(19) United States
(12) Patent Application Publication
(10) Pub. No.: US 2008/0127626 A1
(43) Pub. Date: Jun. 5, 2008

(54) Device for adjusting ornamental chains and method for the manufacture thereof

(75) Inventor: Silverio Cerato, Mussolente (IT)

Correspondence Address: BROWDY AND NEIMARK, P.L.L.C.;624 NINTH STREET, NW, SUITE 300, WASHINGTON, DC, 20001-5303, US

(73) Assignee: Silmar S.p.A., Romano d'Ezzelino (IT)

(21) Appl. No.: 11/646,575

(22) Filed: Dec. 28, 2006

(30) Foreign Application Priority Data
Nov. 30, 2006 (IT) PD2006A000440

(51) Int. Cl. A44C 27/00; A44C 11/02; F16G 13/18; F16G 15/00

(52) U.S. Cl. 59/93; 63/21; 59/80; 29/896.4

(57) ABSTRACT

Device for adjusting ornamental chains, which comprises a hollow containing body provided with at least one pair of diametrically opposite holes and an elastically yielding sleeve arranged inside the hollow containing body and provided with a through-hole arranged aligned with respect to this pair of opposite holes so as to define a channel for receiving the ornamental chain. The tubular sleeve is made of polyurethane reinforced with anti-bacterial additives and is kept compressed inside the hollow containing body.

### TECHNICAL SECTOR

The present invention relates to a device for adjusting ornamental chains and to a method for the manufacture thereof.

The device and the method in question are classifiable within the technical sector relating to the industrial production of precious-metal articles.

The device according to the preamble of the main claim is an accessory for chains, such as necklaces or bracelets, which has in particular the purpose of adjusting the length of the chain which encircles the neck or the wrist of the person wearing it.

### BACKGROUND ART

In the sector for the production of articles of jewelry or their accessories for some time chain adjustment devices have been known, these devices allowing the loop of the ornamental chain which encircles the neck or the wrist of the person wearing it to be lengthened or shortened as required. As a result of this adjustment the piece of jewelry may be easily put on and then shortened in a gradual manner until the correct length around the neck or wrist is found.

These adjustment devices are normally associated with necklaces, bracelets or other ornamental products which use chains and which require variation in the length of the loop formed by them.

The necklace or bracelet adjustment devices which are nowadays present on the market may be of various types depending also on the mechanical system used to cause controlled sliding of the chain within the device and fixing in the desired position.

The type of adjustment device to which the present invention refers exploits the principle of friction in order to adjust the size of the loop.

Japanese patent JP 10295420 discloses a first example of an adjustment device which comprises a hollow containing body which is made of—usually precious—metallic material with a spherical shape and which has, formed therein, two aligned and opposite openings for the insertion of at least one chain. The containing body is diametrically divided by two parallel walls provided with holes aligned with the two openings for receiving the necklace.

Free sliding of the chain inside the device is allowed only following operation of a pushbutton which displaces a locking element slidably inserted between the two diametral walls.

This locking element is provided with a hole, about halfway along its length, for receiving the chain and is subject to the action of a spring which, resting on the inner surface of the container, opposes operation of the pushbutton. In the rest condition, when the pushbutton is not operated, the thrust of the spring on the locking element causes the hole in the latter to become out of alignment with the openings so that the said locking element exerts a shearing force on the chain, thus retaining it in position. When, instead, the pushbutton is operated by means of its external protrusion, it is possible to cause the chain to slide inside the device so as to adjust its length. Advantageously one end of the chain is fastened to a ring fixed on the outside of the containing body.

Alternatively it is possible to cause the two end sections of the same chain to slide alongside each other inside the hole in order to adjust the loop which they form when joining together the said sections.

A similar adjustment device is also described in the patent U.S. 2003/0155383. The Japanese patent JP2001029113 discloses a second example of an adjustment device which, in a similar manner to the previous device, exploits the principle of the shearing action in order to stop free sliding of the chain inside a hollow containing body made of metallic material, in this case with a tubular shape.

This tubular body coaxially receives the chain and has externally a ring for fastening one end of the said chain. An interfering element is elastically fixed to the tubular body so as to obstruct partially the passage of the chain through the said tubular body. In order to adjust the length of the chain, it is sufficient to move this elastic element away slightly so as to allow the chain to slide inside the tubular body.

The patents JP2000139528, JP2000050921, JP 2003180422, JP2001275726 and JP 2003061720 disclose adjustment devices which, differently from the previous examples, exploit the principle of friction and not the shearing force in order to keep the chain fixed in the desired position.

In greater detail, the adjustment devices described in these patents envisage essentially a hollow containing body made of metal, preferably but necessarily with a spherical shape, the surface of which is provided with at least one pair of opposite holes for receiving the jewelry chain. This hollow body houses internally a locking element made of elastic material and provided with a through-cavity aligned with the pair of holes.

This through-cavity has a cross-section with a width less than that of the holes formed in the containing body and greater than the dimensions of the chain so as to fix the latter elastically in the desired adjustment position. In a first configuration the chain has one end connected to a closing ring fixed externally to the hollow body of the device, while the other end of the chain is able to slide inside the hollow body as specified above so as to allow adjustment of its length, and therefore the diameter, of the loop formed by the chain.

Differently, in a second configuration, the hollow body is provided with two pairs of holes which are arranged alongside each other and with which two through-cavities formed in the element made of elastic material coincide internally. In this case, the hollow body receives both the ends of the chain, allowing sliding of its sections one at a time or both simultaneously.

The devices described in the patent JP 2000139528 and in the patent JP 2000050921 envisage that the elastic element consists of a single body, while in a different manner the device described in the patent JP 2003180422 envisages the presence of several elastic elements, for example with a spherical shape, for fixing the chain inside the hollow body.

The patent JP 2001070018 discloses an adjustment device consisting of a hollow containing body with an elongated form and at least one tubular element made of elastic material and inserted inside it. The container is provided with at least one pair of aligned through-holes. A jewelry chain is able to slide inside the containing body through the through-holes and is fixed in position by the elastic compressive action exerted by the tubular element.

In this case the action of the elastic tubular element on the chain is excessive and consequently it is difficult to perform a precise adjustment with minimum movements of the chain.

The patent U.S. Pat. No. 6,470,571 describes an adjustment device and a process for the adjustment thereof, which envisage a hollow body with the elastic element arranged coaxially on the inner wall. In this case, the elastic element acts on the chain only in the region of the holes provided for passage of the chain and therefore in a very small area which does not allow efficient adjustment.

In practice it has been possible to ascertain that, in the solutions of the prior art described above, the displacement of the chain inside the elastic element results in rapid wear of the said elastic element with a consequent loss of its functional capacity to keep the chain in the desired adjustment positions.

Moreover, the industrial processes used hitherto for insertion of the elastic elements inside the hollow bodies are long, impractical and too costly.

### DISCLOSURE OF THE INVENTION

In this situation, the main object of the present invention is to provide a device for adjusting ornamental chains which is able to provide very precise adjustment and maintain it over time.

Another object of the present invention is to provide a device for adjusting ornamental chains which has a high anti-microbial resistance.

A further object of the present invention is to provide a method for manufacturing a device for adjusting ornamental chains which is simple and inexpensive to implement.

### BRIEF DESCRIPTION OF THE DRAWINGS

The technical features of the invention, in accordance with the abovementioned objects, may be clearly determined from the contents of the claims indicated below and the advantages thereof will emerge more clearly from the detailed description which follows, provided with reference to the accompanying drawings, which shows a purely exemplary and non-limiting embodiment in which:

FIG. 1 shows a device for adjusting ornamental chains in accordance with the present invention;

FIG. 2 shows a cross-sectional view of the device according to FIG. 1;

FIGS. 3A, 3B, 3C and 3D show four stages of the method according to the invention for manufacturing the adjustment device according to FIG. 1.

### DETAILED DESCRIPTION

With reference to the accompanying drawings, 1 denotes overall a device for adjusting ornamental chains according to the present invention.

This device is intended to be used in order to vary the size of the loop formed by the chain of an article of jewelry such as a necklace, a bracelet or a similar article, it being understood, however, without departing from the scope of protection of the present invention, that the said device may also be used for other items of jewelry or articles of a different kind provided that they likewise use a chain which requires adjustment.

The chain to be adjusted may be made of any material and in any form, even though preferably the device according to the invention has been mainly designed for use in the jewelry sector in order to adjust the length of chains or bracelets formed by links made of gold, silver, other precious or semi-precious metals or alloys thereof.

As is known in fact, the loop of the chains which encircles the neck or wrist of the persons wearing the associated article advantageously needs to be adjusted. In particular, it is normally required to have the possibility of making this loop bigger so as to be able to easily put on the article and then also be able to shorten the said loop once the article is worn, albeit solely for aesthetic reasons.

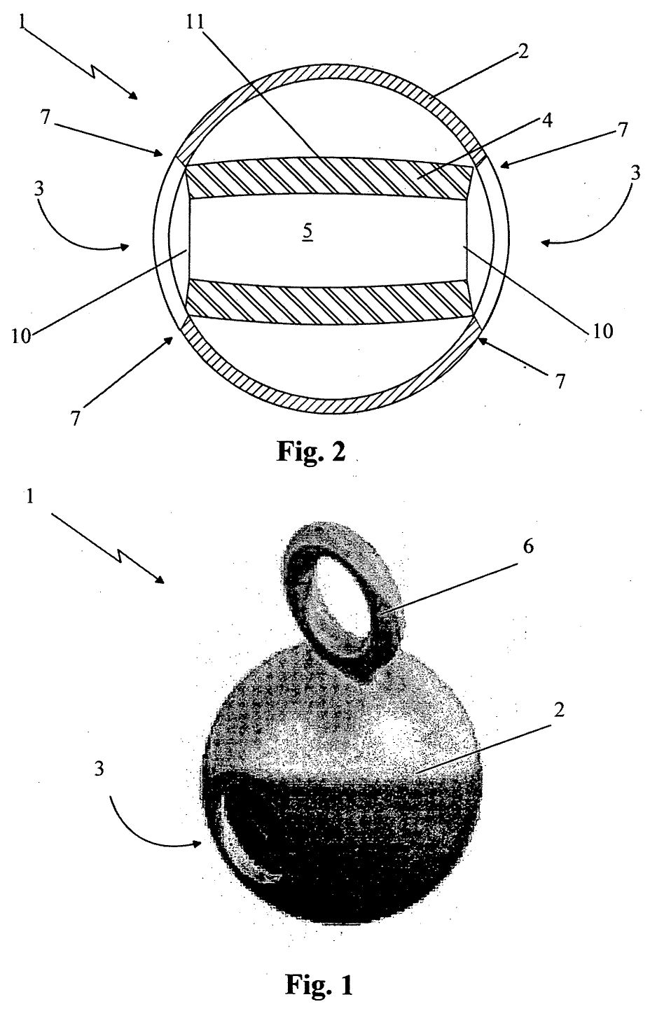

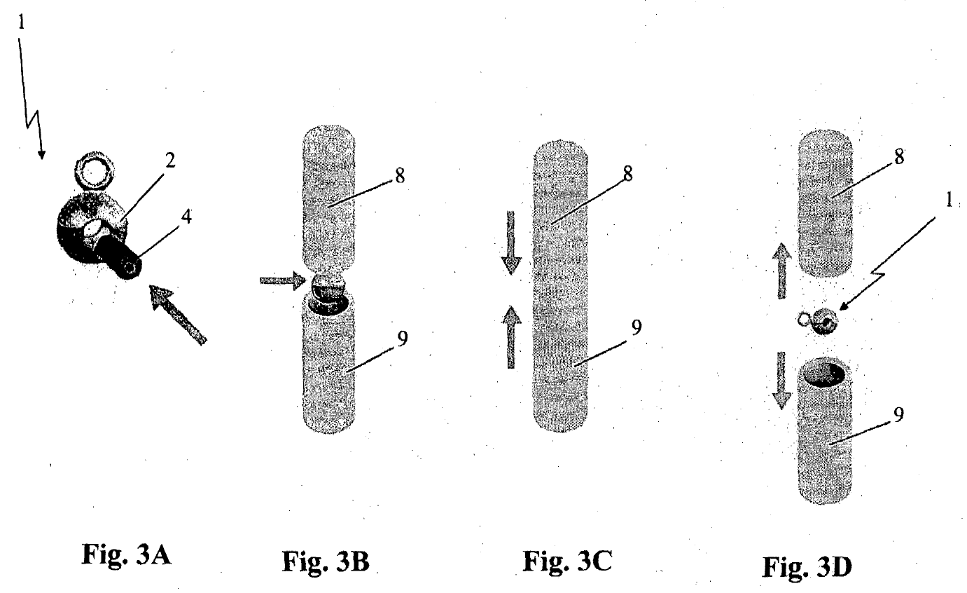

In accordance with the drawing according to FIG. 1, the device 1 comprises a hollow and preferably spherical shaped containing body 2 provided with a pair of diametrically opposite holes 3 and an elastically yielding tubular sleeve 4 arranged inside the hollow containing body 2 and provided with a through-hole 5 arranged aligned with respect to the pair of opposite holes 3.

The opposite holes 3 and the through-hole 5 define a channel for receiving the ornamental chain to be adjusted.

The adjustment device 1 will be necessarily associated with a chain having dimensions slightly smaller than the diameter of the opposite holes 3 and dimensions slightly bigger than the through-hole 5.

According to the idea forming the basis of the present invention the tubular sleeve 4 is retained in a compressed manner inside the hollow containing body 2 which defines a housing with dimensions smaller than the tubular sleeve 4 if the latter should be able to expand freely.

Moreover, the tubular sleeve 4 consists of a thermoplastic material of suitably elasticity and hardness chosen from within the group comprising:

Thermoplastic polyurethanes, thermoplastic polyurethanes elastomerized with styrene block copolymer elastomers, elastomeric polyolefins and elastomeric copolyesters.

Advantageously thermoplastic polyurethanes whose soft segment consists of the following:
polyester
polytetramethylene glycol ether
polycaprolactone diol
carbonate ester diol
and the isocyanic base of which consists of aliphatic isocyanates (HDI, IPDI, H12 MDI) and/or aromatic isocyanates (MDI and TDI), are used.

Even more advantageously, the abovementioned thermoplastic polyurethane is of the carbonate ester diol type, the good anti-microbial resistance of which is well-known, chosen in the hardness range of 70 Shore A to 50 Shore D.

In accordance with a further characteristic feature of the device 1 according to the invention, the thermoplastic material is enriched during its formation with an additive having an anti-microbial action preferably consisting of a solution of 2-Octyl-2H-isothiazol-3-one and Triclosan—known under the trade name of “Sanitized”—present in a percentage varying from 0.3 to 1% by weight of the polymer.

A ring 6 is fixed projecting from the external surface 6 in order to allow fastening of one end of the chain (not shown).

The present invention also relates to a method for manufacturing a device for adjusting ornamental chains, in particular of the type described above, whose same reference numbers will also be used below.

This method comprises the operating steps described in detail hereinbelow.

Initially a step involving pressing from a plate made of metal, in particular a precious metal (such as gold or silver), semi-precious metal or an alloy of a precious metal, is envisaged.

By means of this pressing step a plurality of hollow containing bodies 2 each with a pair of opposite holes 3 are obtained.

It is also envisaged performing a step involving extrusion of a polyurethane tube 4 with a diameter substantially equal to or slightly smaller than that of the holes 3 provided in the hollow body 2.

During a subsequent step, the hollow bodies 3 are mounted on a polyurethane tube 4 which therefore passes through the pairs of opposite holes 3.

A step involving cutting with a blade which is inserted between the hollow bodies 2 arranged adjacent to each other is then performed so as to cut off the polyurethane tube 4 flush with the outer openings of the opposite holes 3.

At this point, a plurality of semi-finished products is obtained, each of said products consisting of a hollow body 2 with a polyurethane tubular sleeve 4 arranged inside it.

A step involving a reduction in the size of each semi-finished product thus obtained is then envisaged so as to cause compression of the tubular sleeve 4 inside the hollow body 2. The elastic reaction of the sleeve 4 exerted on the inner surface of the hollow body 2 in contact areas 7 situated in the vicinity of the holes 3 ensures adhesion of the said sleeve 4 even when, during adjustment, it is envisaged that it exerts an elastic action and a frictional force on the chain.

Advantageously, this reduction in the size is obtained by means of punching arranging, as shown in FIGS. 2B, 2C and 2D, the said hollow body 2 between a mould 8 and a counter-mould 9. These facing moulds or punches 5 and 6 are shaped substantially according to the profile of the hollow body 2, but with a shape slightly smaller than that of the hollow body 2.

In this way it is possible to reduce the dimensions of the hollow body, while keeping unchanged the external appearance, in particular the spherical form, and forcing the sleeve 4 to remain firmly inside it.

The cavities of the moulds 8 and 9 are slightly flared at the free edges where the shape of the hollow body 2 is followed again exactly in order to prevent, during punching with closing of the moulds 8 and 9, the formation of marks along the plane of contact of the two said moulds 8 and 9.

Advantageously, the cylindrical sleeve 4, following the compression to which it is exposed as a result of punching, is deformed slightly with the side surface 10 assuming a slight curvature (see FIG. 2) and with the end surfaces 11 which collapse slightly towards the through-hole 5.

In this way, the two end faces 10 of the cylindrical sleeve 4, after punching, advantageously are inset slightly towards the inside of the hollow body 2 and in this way prevent the formation (due also to machining imprecision or cutting operations) of undesirable projecting burrs or parts of the polyurethane sleeve which otherwise would have to be finished during a subsequent operation.

Advantageously polyurethane lends itself for production by means of extrusion in the desired colours, in particular suitable for correct combination with the colours of the hollow body 2.

Obviously, the use of the device is subject to a step involving insertion of at least one end of the chain inside the channel 5 of the tubular sleeve.

The invention thus conceived therefore achieves the predefined objects.

Obviously, it may assume in its practical embodiment also forms and configurations different from that illustrated above without thereby departing from the present scope of protection.

Moreover, all the details may be replaced by technically equivalent parts and the dimensions, the forms and the materials used may be of any nature according to requirements.

1. Device for adjusting ornamental chains, which comprises a hollow containing body 2 provided with at least one pair of diametrically opposite holes; at least one elastically yielding tubular sleeve arranged inside said hollow containing body and provided with a through-hole arranged aligned with respect to said pair of opposite holes, said opposite holes and said through-hole defining a channel for receiving at least one ornamental chain having dimensions slightly smaller than the diameter of said opposite holes and dimensions slightly bigger than the diameter of said through-hole, so as to apply an elastic force on said chain, characterized in that said tubular sleeve is retained in a compressed manner inside said hollow containing body and is made of a thermoplastic material chosen from within the group comprising thermoplastic polyurethanes, thermoplastic polyurethanes elastomerized with styrene block copolymer elastomers, elastomeric polyolefins and elastomeric copolyesters.

2. Device according to claim 1, in which said thermoplastic material is of the carbonate ester diol type, which is known to have a good anti-microbial resistance, being chosen in the hardness range of 70 Shore A to 50 Shore D.

3. Device according to claim 1, in which the soft segment of said thermoplastic polyurethane consists of:
polyester
polytetramethylene glycol ether
polycaprolactone diol
carbonate ester diol
and the isocyanic base of which consists of aliphatic isocyanates (HDI, IPDI, H12 MDI) and/or aromatic isocyanates (MDI and TDI).

4. Device according to claim 1, in which said thermoplastic material is reinforced with an additive having an anti-microbial and/or anti-allergic action.

5. Device according to claim 4, in which said anti-microbial additive consists of a solution of 2-Octyl-2H-isothiazol-3-one and Triclosan—known by the trade name of “Sanitized”—present in a percentage varying between 0.3 to 1% by weight of the polymer.

6. Method for manufacturing a device for adjusting ornamental chains, comprising the following operating steps:
pressing of a plate made of metal, in particular a precious metal, semi-precious metal or an alloy of a precious metal, so as to obtain a plurality of containing bodies each provided with a pair of opposite holes 3;
extrusion of a polyurethane tube;
insertion of said hollow bodies, by means of the pair of opposite holes, onto said polymer tube;
cutting of said polyurethane tube along the outer openings of said opposite holes so as to obtain a plurality of hollow bodies, each with a polyurethane tubular sleeve arranged inside it;
reduction, by means of punching, of the size of each hollow body with inside said hollow sleeve, such as to cause compression of said hollow body and its elastic reaction against the inner surface of said hollow body in areas of contact 7 situated in the vicinity of the holes 3;
insertion of at least one end of said chain inside the channel of said tubular sleeve.

7. Method according to claim 6, in which said punching step is performed by compressing said hollow body between two shaped moulds able to reduce the dimensions of said hollow body, keeping them however unchanged along the contact plane of the two moulds so as to avoid the formation of moulding marks or roughness.

8. Method according to claim 6, in which said hollow body is a sphere which is slightly flattened after the punching step.

9. Method according to claim 6, in which said cylindrical sleeve following said punching is deformed with end surfaces slightly inset towards the inside said hollow body.
